(19) United States
(12) Patent Application Publication
(10) Pub. No.: US 2013/0061179 A1
(43) Pub. Date: Mar. 7, 2013

(54) IDENTIFICATION AND ESCALATION OF RISK-RELATED DATA

(71) Applicants: Elizabeth A. Alletto, Upton, MA (US); Elizabeth A. Abramek, Smithfield, RI (US); Kimberly A. Cabral, Warren, RI (US); James C. Foskett, Haverhill, MA (US); Michael W. Kessler, East Meadow, NY (US); Ellen H. Larson, Jacksonville, FL (US); Virginia S. Allmond, St. Augustine, FL (US); Aleksandr M. Talyanker, Jacksonville, FL (US)

(72) Inventors: Elizabeth A. Alletto, Upton, MA (US); Elizabeth A. Abramek, Smithfield, RI (US); Kimberly A. Cabral, Warren, RI (US); James C. Foskett, Haverhill, MA (US); Michael W. Kessler, East Meadow, NY (US); Ellen H. Larson, Jacksonville, FL (US); Virginia S. Allmond, St. Augustine, FL (US); Aleksandr M. Talyanker, Jacksonville, FL (US)

(73) Assignee: Bank of America, Charlotte, NC (US)

(21) Appl. No.: 13/227,303

(22) Filed: Sep. 7, 2011

(51) Int. Cl. G06F 3/048

(52) U.S. Cl. 715/843

(57) ABSTRACT

Apparatus for processing customer information is provided. The apparatus may include a receiver configured to receive information relating to a customer. The information may satisfy pre-determined criteria. The pre-determined criteria is arranged to support a qualification of the customer as a high risk customer. The information may be received from one of a plurality of third party vendors. The information may include a client identification number, a client tax number and a client social security number. The apparatus may also include a processor configured to cause a graphical user interface (“GUI”) to display a plurality of user roles in a drop-down menu. Each of the user roles defines a set of user entitlements. In the event that the financial institution database includes information relating to the high risk customer, the processor may be further configured to transfer the information to one or more of a plurality of receivers.

### FIELD OF TECHNOLOGY

This invention relates to data processing. More specifically, this invention relates to processing risk-related data.

### BACKGROUND OF THE DISCLOSURE

In some countries, financial institutions are required to monitor the behavior of their customers to identify potentially illegal behavior. Typically, these financial institutions use automated systems to assist them in their monitoring of customer behavior. Such automated systems use algorithms to analyze customer databases to detect risk-related behaviors, detectable in the form of risk-related data, that may relate to illegal behavior. In the event that a customer's data is determined to be risk-related, the customer data is forwarded to a banking associate who determines an appropriate course of action in dealing with the customer.

Many of these automated systems require reprogramming in the event that a new algorithm is desired to be implemented to identify risk-related behavior. This is not desirable at least because reprogramming may require a significant amount of time, delaying the identification of the risk-related behavior.

It would be desirable, therefore, to provide an automated system that enables a user to utilize and/or implement new methods for identifying risk-related behavior without needing to reprogram the system.

### SUMMARY OF THE DISCLOSURE

In general, users assist in identification of risk-related issues to track regarding clients or potential clients. The tool, according to the invention, may be used by users to tracking risk-related issues. In some aspects of the invention, the tool may be used by users to further refine system-implemented issue identification. The user refinement of the issue identification may be tracked in the tool. Accordingly, one aspect of the tool may be understood to be a way to record progress in tracking the issues.

A method for electronically processing customer information is provided. The method may perform steps identifying and escalating risk-related data. The method may include using a receiver to receive information relating to a customer. The information that may satisfy pre-determined criteria. The pre-determined criteria may qualify the customer as a high risk customer. The information may be received from one of a plurality of third party vendors. The information may include a client identification number, a client tax number and a client social security number. The method may further include using a processor to cause a graphical user interface (“GUI”) to display a plurality of user roles in a drop-down menu. Each of the user roles may define a set of user entitlements. In the event that the financial institution database includes information relating to the high risk customer, the method may further include transferring the information to one or more of a plurality of receivers.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a process flow that may be used in accordance with the systems and methods of the invention;

FIG. 3 shows another process flow that may be used in accordance with the systems and methods of the invention; and

FIG. 4 shows yet another process flow that may be used in accordance with the systems and methods of the invention.

### DETAILED DESCRIPTION OF THE DISCLOSURE

The systems and methods of the invention relate to a tracking tool configured to process customer data that has been identified as risk-related data. The risk-related data may be data that potentially relates to money laundering, fraud, corruption, regulatory and suspicious activity, organized crime, terrorist financing, sanctions, USA PATRIOT Act non-compliance and any other suitable risks.

The tracking tool may receive the risk-related data from one or more databases. The one or more databases may be supported by a financial institution that runs the tracking tool and/or by one or more third-party vendors. The tracking tool may also receive the risk-related data from the financial institution and/or the third-party via a manual load. Alternately, the tracking tool may extract the risk-related data from the databases using a batch process upon the lapse of one or more predetermined time periods.

The following chart illustrates exemplary risk-related data that may be received by the tracking tool according to the invention:

| | | | Final |
|---|---|---|---|
| | | | Disposition |
| Risk Type | Data Source | Review Process | Options |
| Financial | Data received from third-party | Tool is used to track user | Maintain or |
| Derogatory | vendors based on customer data | research and | Exit |
| Alert | provided from account opening | recommendations on the | Relationship |
| | systems | issue in question | |
| | | Tool generates | |
| | | Reports/Notifications | |
| | | based on user defined | |
| | | rules | |
| Negative | Data received from third-party | Tool is used to track user | Maintain or |
| News Alert | vendors based on customer data | research and | Exit |
| | provided from account opening | recommendations on the | Relationship |
| | systems | issue in question | |
| | | Tool generates | |
| | | Reports/Notifications | |
| | | based on user defined | |
| | | rules | |
| Senior | Data received from a third-party | Tool is used to track user | Maintain or |
| Political | based on the screening of selected | research and | Exit |
| Figure Alert | customer records from a Financial | recommendations on the | Relationship |
| | Account Source of Record | issue in question | |
| | Data received via referrals from line | Tool generates | |
| | of business branches | Reports/Notifications | |
| | | based on user defined | |
| | | rules | |
| Customer Due | Defects in customer data are | Tool is used to track user | Repair |
| Diligence | received by the application. Data | research and | Account or |
| Defect | may be validated with third-party | recommendations on the | Exit |
| Tracking | that performs checks against | issue in question | Relationship |
| | financial databases to confirm | Tool processes data | |
| | customer identity | Tool generates | |
| | | Reports/Notifications | |
| | | based on user defined | |
| | | rules | |
| Account | Data received from an Investigative | Tool is used to track user | Maintain or |
| Closure | Service | research and | Exit |
| Recommendations | | recommendations on the | Relationship |
| | | issue in question | |
| Economic | Data received from a third-party that | Tool conducts research | Maintain or |
| Sanctions | checks for high level criminal, civil | on the account in | Exit |
| | and/or money laundering related | question | Relationship |
| | negative media information on a | | Account close |
| | client | | recommenda- |
| | | | tion issued by |
| | | | Economic |
| | | | Sanctions |
| | | | Organization |
| Corporate | Data generated from a Due Diligence | Tool determines extent of | Maintain or |
| Security Alert | Investigations Group that searches a | financial institution | Exit |
| | Corporate Security Case | relationship | Relationship |
| | Management System to determine if | | |
| | a client has been investigated in the | | |
| | past | | |
| | Data received from a third-party that | | |
| | checks for high level criminal, civil | | |
| | and/or money laundering related | | |
| | negative media information on a | | |
| | client | | |
| Investigative | Data received from investigative | Tool determines if the | Maintain or |
| Team Account | teams (e.g., Global Anti-Money | data relates to a client of | Exit |
| Closure | Laundering Investigative teams) | the financial institution | Relationship |
| Recommendations | | Tool identifies any | |
| | | additional related parties | |
| | | Tool confirms what line | |
| | | of business the client is | |
| | | managed in | |
| High | Data received from searching of data | Tool is used to track user | Account |
| Risk/Special | sources other than those that relate to | research and | approval or |
| Policy Review | financial institution customers | recommendations on the | denial |
| | | issue in question | |
| Red Flag | Data received internally from the | Tool tracks user research | Maintain or |
| Escalation | financial institution which is | which allows users to | Exit |
| | generated by analyzing bank | determine the validity of | Relationship |
| | resources within a defined group of | the escalation | |
| | customers or prospects | | |
| Client | Data received as an ad hoc request to | Tool conducts research | Maintain, exit |
| Background | conduct an investigation on a | on the identified client | relationship, |
| | prospect or current client | that includes open source | or do not |
| | | research and database | move forward |
| | | searching | with new business |
| Credit | Data received from a corporate | Tool is used to track user | Terminate |
| Underwriting | security database when a customer | research and | loan process |
| | has requested a credit underwriting | recommendations on the | or continue |
| | and previous investigation has | issue in question | normal vetting |
| | identified money laundering data | | process |
| | relating to the client | | |
| Re-Entry | Data received from an anti-money | Tool tracks user research | Maintain or |
| Prevention | laundering global and economic | and recommendations to | Exit |
| Alert | sanctions team that monitors a list of | determine whether a | Relationship |
| | clients that have previously been | client is allowed to re- | |
| | required to exit a relationship with | enter into business with | |
| | the financial institution and are not | the financial institution | |
| | allowed to re-enter business with the | | |
| | financial institution | | |

The risk-related data may include data identifying one or more customers. The data may include a customer name, address, tax ID number, social security number, and/or any other suitable identifying data.

In the event that a user of the tracking tool determines that the data identifies a customer affiliated with the financial institution, and that the customer meets certain risk-based criteria, the tracking tool may be used to generate one or more reports. The reports may be time-based or event-based. The reports may include workflow statistical reports, trend reports and/or provide linkage to a system of record that includes the reported information.

The one or more reports may be sent to one or more predetermined addresses. For example, designated reports may be sent to a specified e-mail address. Such an e-mail address may be associated with third-party vendors. It should be noted that the destination of the reports may be based on the nature of the data received by the tracking tool.

In the event that the risk-related data meets one or more predetermined conditions, the tracking tool may transmit the data daily, weekly, and/or during any other predetermined time period to one or more predetermined addresse(s).

In an exemplary embodiment, at the close of each month, or any other suitable time period, the tracking tool may source data to a Financial Investigations Unit (“FIU”) that relates to (1) elevated risk clients that were determined by banking personnel to require FIU monitoring and (2) elevated risk clients identified by analyzing data relating to the opening of customer accounts. Data elements sourced to the FIU may include business name, customer name, address, country of origin, country of residence, party ID, tax ID number, account number, etc.

It should be noted that the tracking tool may maintain a record of all transmitted risk-related data. The tracking tool may also maintain a record of when the transmitted data was sent. The tracking tool may additionally notify banking associates regarding a failure to deliver risk-related data to its intended recipients.

It should additionally be noted that the tracking tool may employ systems and methods to maintain an active list of users within the application. In some embodiments, the tracking tool may maintain the active list by sourcing data to a Corporate Security Database (“CSDB”). In these embodiments, the tracking tool may retrieve a terminations file from the CSDB and compare the terminated user IDs to the active user IDs in the tracking tool. The tracking tool may then render inactive any active user IDs that match user IDS contained in the CSDB list. The tracking tool may then update an audit log with date and time that the user ID was deactivated. The tracking tool may additionally send notification via email, or other electronic transmission formats, to an Application Administrator or any other suitable user and/or tester that has been granted one or more entitlements within the tracking tool. The notification may list the name and role of the user(s) that have been deactivated.

The tracking tool according to the invention may include a user interface. The user interface may be web-based and may include password-encoded access. Each user that accesses the user interface may be granted one or more roles and/or permissions within the user interface. User permissions may vary based on the Risk Type that the user desires to access.

The following chart illustrates exemplary roles that a user may have within one or more Risk Types included in the tracking tool:

| Role | Entitlements |
|---|---|
| Application | ability to create and maintain risk type templates, |
| Administrator | their data entry fields, and associated workflow |
| | process within the tracking tool |
| Risk Definition | ability to approve a new/updated risk type/process |
| Acceptance Tester | created by the Application Administrator |
| User Administrator | ability to control tracking tool user access, |
| | roles and entitlements enablement |
| Risk Definition | ability to test new or updated risk type template |
| Unit Tester | created by the application administrator (inherent |
| | role with Application Administrator) |
| Risk Tracking | entitlements in this area are based on the Risk Type: |
| | manager |
| | processor |
| | read only |
| | none (default) |

It should be noted that within each role, a user may have no entitlements, full entitlements, or read-only entitlements. A user's default entitlement(s) within each role may be none. The roles assigned to a user may control the user interface display that is displayed after login. In the event that a user has been granted multiple roles within the tracking tool, the user may have a designated default role that controls the display displayed after login.

The user interface may enable a user to retrieve and manipulate data sourced into the tracking tool by the financial institution and/or the third-party vendors. For example, the user interface may enable a user to access risk-related data sourced into the tracking tool. The user may use this data to determine which clients must be tracked for one or more Risk Types.

Additionally, the user interface may enable a user to search data associated with one or more Risk Types included in the tracking tool. In some embodiments, the user interface may enable the user to search the one or more databases associated with the one or more Risk Types using a key word search. In these embodiments, the user may search for a client by searching a client first/last name, tax ID number, unique client identifier defined by LOB, account number, or other defined attributes.

The user interface may further enable a user to add or retire one or more Risk Types, Risk Definitions and/or Workflows associated with the Risk Definitions.

Specifically, the tracking tool may contain multiple Risk Types that track specific risk issues. Each Risk Type may have a Risk Definition that specifies the components presented for tracking the associated Risk Type. Exemplary Risk Definitions may include Risk Type name, primary basis (client), secondary basis (e.g., account, loan application), primary basis/secondary basis relationship (e.g., 1-to-1, 1-to-many), workflow, status resulting from action, supporting data attributes, data confidentiality rules, alert notification rules, roles and reports.

The user interface may categorize a Risk Definition as pending, published or retired. A pending Risk Definition may relate to a Risk Definition whose definition is being created and components are being built. A published Risk Definition may relate to a Risk Definition that is available for selection in risk tracking and that may be retired by an authorized user. A retired Risk Definition may relate to a previously published Risk Definition that has been replaced with a published Risk Definition and is no longer available for use in risk tracking. A retired Risk Definition may be stored in the tracking tool for use during historical data analysis.

The user interface may include a validation environment. The validation environment may enable a user to test a pending Risk Definition. The validation environment may be used prior to implementing the pending Risk Definition in the tracking tool. The validation environment may provide a full suite of testing capability by enabling the user to fully test the pending Risk Type, inclusive of importing data and generating reports. The validation environment may terminate the process at the output step to enable the Tester to review generated output without transmitting the data to any recipient.

For example, an Application Administrator may select a pending Risk Definition from a Risk Definitions list. The Application Administrator may then build/edit the Risk Definition. The Application Administrator may then send a completed Risk Definition version to a Risk Definition Unit Tester. The Risk Definition Unit Tester may then test the functionality of the Risk Definition by creating/updating a client risk issue record within the Risk Definition Unit Test environment.

Upon completion of the unit testing, the Application Administrator may send the Risk Definition version to a Risk Definition Acceptance Tester. The Acceptance Tester may test the functionality of the Risk Definition by creating and/or updating a client risk issue record within the Risk Definition Acceptance Test environment. The Acceptance Tester may notify the Application Administrator of any defects found in testing. Upon completion of Acceptance Testing, the Application Administrator may publish the Risk Definition version.

It should be noted that in the event that a user has been allotted multiple roles within the user interface, the user interface may enable a user to switch between roles without having to log out and back in. In an exemplary embodiment, the tracking tool may include a drop-down menu that displays the user's allotted roles. In the event that the user desires to switch between his roles, the user may use the drop-down list to change his or her role.

For example, an exemplary user may be granted an Application Administrator role, a Risk Definition Unit Tester role and/or a Risk Tracking role. The user may access the user interface according to the invention via a user name and password. In the event that the user's default role is the Risk Tracking role, the tracking tool may initially display a dashboard that reflects the entitlements included within the Risk Tracking Role. After login, the user may desire to add or update a Risk Type. The user may add or update the Risk Type by switching to his Application Administrator role. The user may initiate this switch by selecting ‘Application Administrator’ from a drop-down menu included on his Risk Tracking dashboard.

Upon selection of ‘Application Administrator,’ the user interface may display the Administrator dashboard. Upon completion of the administrative tasks, the user may desire to switch to the Risk Definition Unit Tester role to begin validating the changes made while in the Administrator role. The user may use the drop-down menu to select ‘Risk Definition Unit Tester.’ Upon selection of ‘Risk Definition Unit Tester,’ the user may view a Risk Definition Unit Tester dashboard, validate the changes made, and subsequently use the drop-down menu to switch back to his Risk Tracking Role and resume normal activity.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

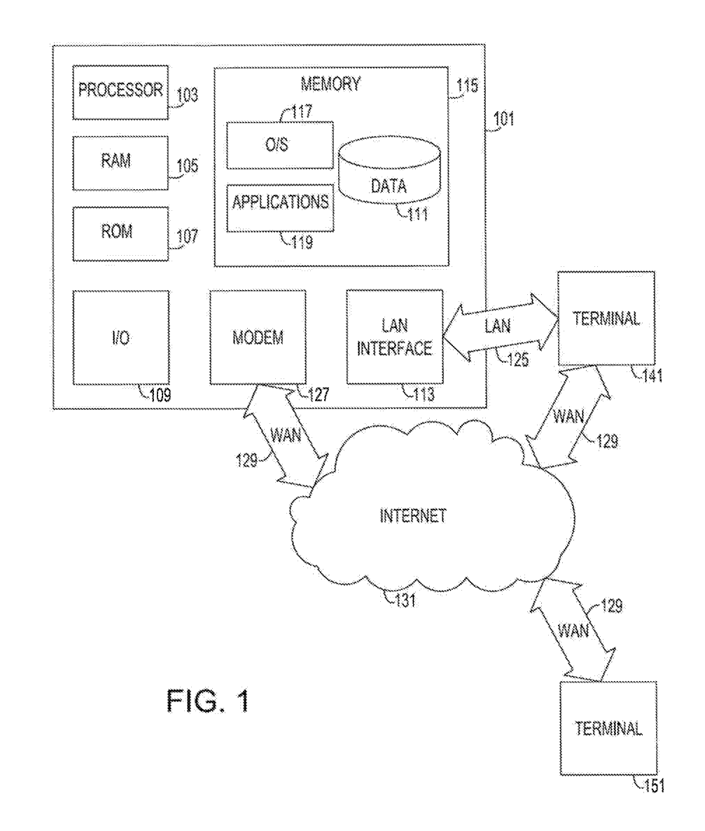

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information; automatic withdrawal service information, and/or any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by an administrator to open, view and process customer information and to issue one or more instructions regarding the tracking tool. Customer information may be stored in memory 125. The customer information may be processed by an application such as one of applications 119.

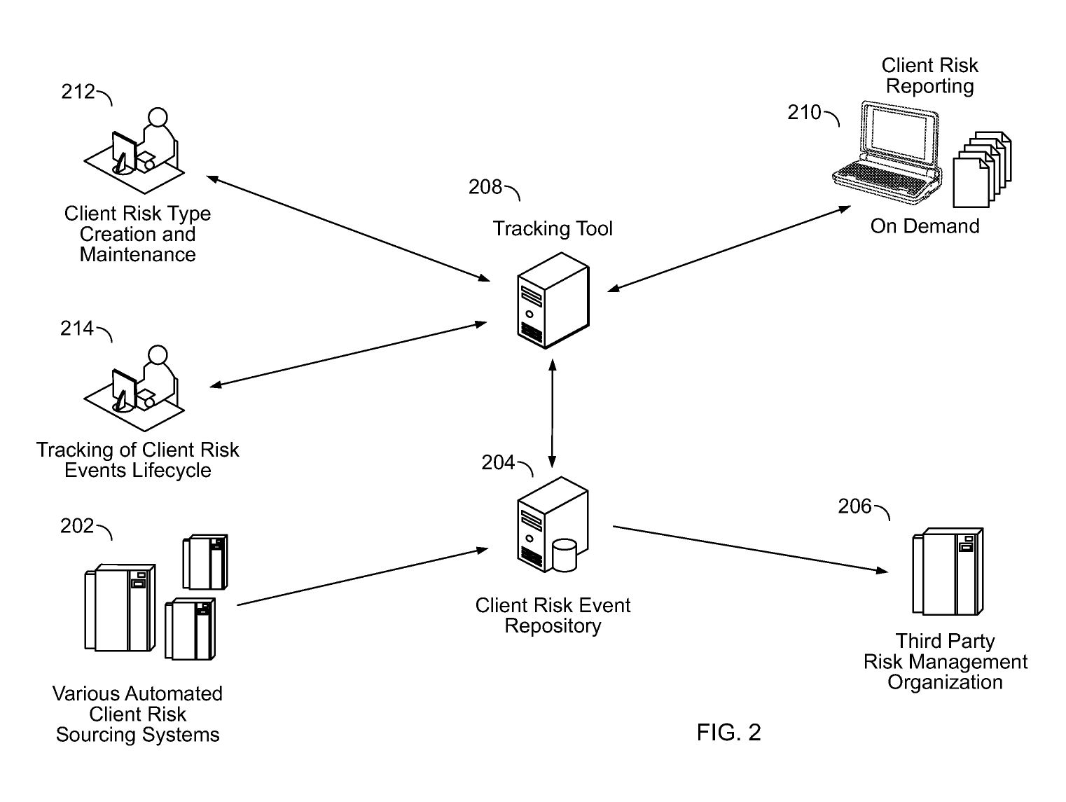

FIG. 2 shows a process flow that may be used in accordance with the systems and methods of the invention. In the process flow, Client Risk Event Repository 204 may receive risk-related data from Various Automated Client Risk Sourcing Systems 202. Client Risk Event Repository 204 may transmit the received data to Tracking Tool 208 and one or more Third Party Risk Management Organizations, including Third Party Risk Management Organization 206.

Tracking Tool 208 may be in two-way communication with Client Risk Type Creation and Maintenance 212, Tracking of Client Risk Events Lifecycle 214 and/or Client Risk Reporting. Tracking Tool 208 may receive and transmit risk-related data from Client Risk Type Creation and Maintenance 212, Tracking of Client Risk Events Lifecycle 214 and/or Client Risk Reporting.

It should be noted that Client Risk Type Creation and Maintenance 212, in addition to Tracking of Client Risk Events Lifecycle 214, may be accessed by one or more authorized users via the user interface according to the systems and methods of the invention.

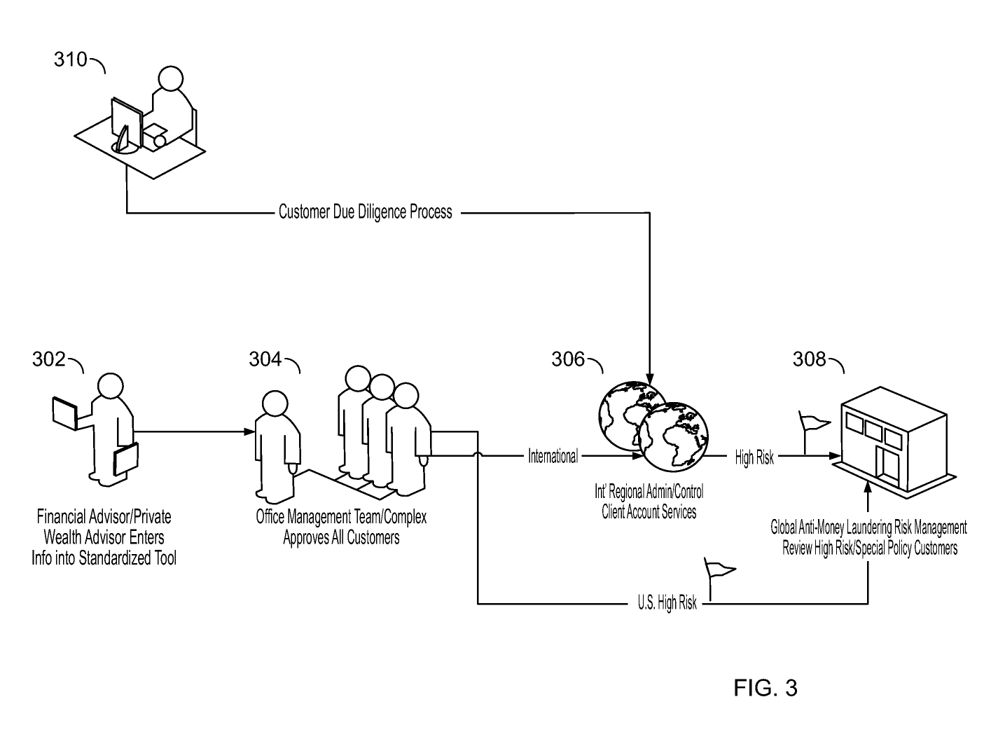

FIG. 3 shows another process flow that may be used in accordance with the systems and methods of the invention. In the process flow, a Financial Advisor and/or a Private Wealth Advisor may enter customer data into a Standardized Tool. The Standardized Tool may be associated with one or more financial institution databases.

Upon receipt of a notification of the entered data, a Risk Management Team may approve the customer(s) associated with the entered data. The Office Management Team may additionally flag one or more U.S. customer(s) associated with entered U.S. data as U.S. High Risk customers. Data relating to the flagged customers may be input into a Global Anti-Money Laundering Risk Management Review for High Risk/Special Policy Customers. The data may also be input into the tracking tool according to the systems and methods of the invention.

The Risk Management Team may also transmit data relating to international customers, international accounts and/or other suitable data to an International Regional Administration/Control Client Account Services database. One or more banking associates affiliated with the International Client Account Services may review the transmitted data.

In the event that a banking associate determines that one or more customers associated with at least a portion of the transmitted data should be classified as a high risk customer, data relating to the customer may be input into the Global Anti-Money Laundering Risk Management Review for High Risk/Special Policy Customers. The data may also be input into the tracking tool according to the systems and methods of the invention.

It should be noted that in some embodiments, the functionalities of one or more of the aforementioned steps may be executed electronically by one or more processors using one or more algorithms. For example, the approval of newly-entered customer data may be electronically approved using one or more algorithms configured to process customer data. Additionally, the characterization of U.S. and/or international customer data as high risk may be electronically executed as well.

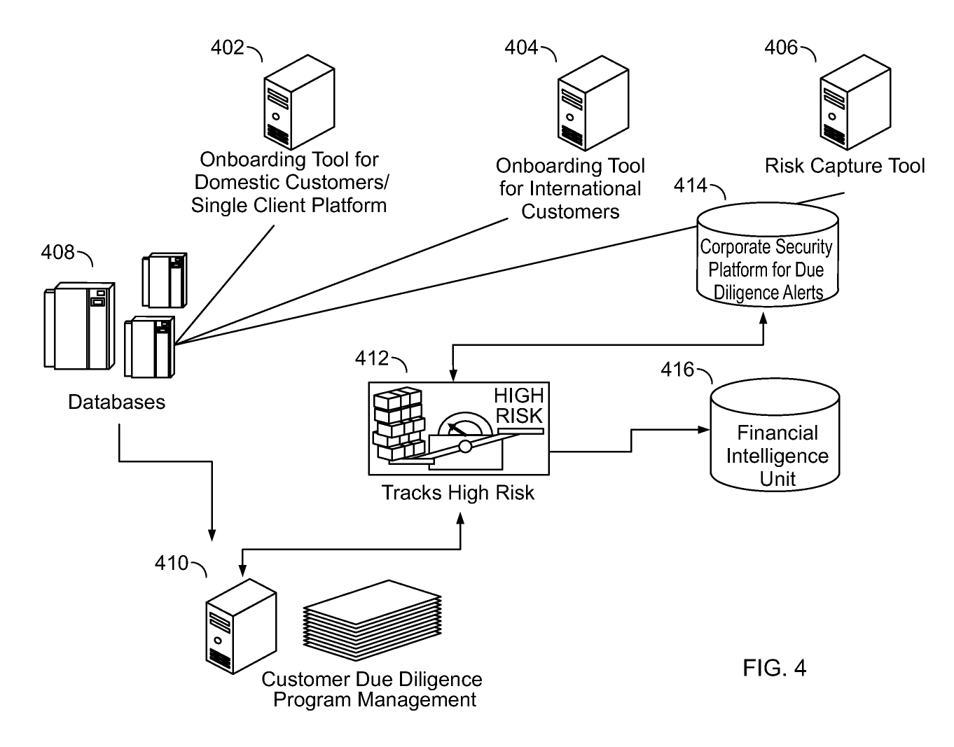

FIG. 4 shows yet another process flow that may be used in accordance with the systems and methods of the invention. In the process flow, information may be fed into Database(s) 408 via Onboarding Tool for Domestic Customers/Single Client Platform 402, Onboarding Tool for International Customers 404 and Risk Capture Tool 406. Database 408 may transmit the data to Customer Due Diligence Program Management 410, which may subsequently transmit the received data that relates to high risk customers to a Tracking Tool 412 according to the systems and methods of the invention.

Tracking Tool 412 may track the high risk customers. Tracking tool 412 may additionally transmit information relating to the high risk customers to Financial Intelligence Unit 416 upon the lapse of one or more predetermined time periods. Tracking tool 412 may additionally transmit and/or receive information relating to high risk customers from Corporate Security Platform for Due Diligence Alerts 414.

Thus, methods and apparatus for processing risk-related data in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for processing customer information, the apparatus comprising:
a receiver configured to receive information relating to a customer, said information that satisfies pre-determined criteria, said pre-determined criteria that qualifies the customer as a high risk customer, from one of a plurality of third party vendors, the information including a client identification number, a client tax number and a client social security number;
a processor configured to assess, in response to a user login, all roles to which the user is entitled, and further configured to use a graphical user interface (“GUI”) to display a plurality of user roles in a drop-down menu, each of the plurality of roles being roles to which the user is entitled, the processor yet further configured to present the user a mechanism for switching between the roles; and
in the event that the financial institution database includes information relating to the high risk customer, the processor is further configured to transfer the information to one or more of a plurality of receivers.

2. The apparatus of claim 1, wherein the mechanism comprises a drop-down menu.

3. The apparatus of claim 2, wherein the processor is further configured to display an application administrator role in the drop-down menu, the application administrator role comprising the ability to create and maintain risk type templates.

4. The apparatus of claim 3, wherein the processor is further configured to display a risk definition acceptance tester role in the drop-down menu, the risk definition acceptance tester role comprising the ability to approve a new and/or updated risk type process created by the application administrator role.

5. The apparatus of claim 2, wherein the processor is further configured to display a user administrator role in the drop-down menu, the user administrator role comprising the ability to control tracking tool user access.

6. The apparatus of claim 3, wherein the processor is further configured to display a risk definition unit tester role in the drop-down menu, the risk definition unit tester role comprising the ability to test new or update risk type template created by the application administrator.

7. The apparatus of claim 2, wherein the processor is further configured to display a risk tracking role in the drop-down menu, the risk tracking role comprising entitlements based on the risk type, the entitlements comprising manager, processor and read only.

8. The apparatus of claim 2, wherein the risk type comprises at least one of a financial derogatory alert, a negative news alert, a senior political figure alert, a defect tracking alert, an account closure recommendation alert, an economic sanctions alert, a corporate security alert, an investigative team account closure recommendation alert, a high risk/special policy review alert, a red flag escalation alert, a client background, a credit underwriting alert, a pre-entry prevention alert and any other suitable alert.

9. The apparatus of claim 2, wherein the plurality of receivers include at least one of a line of business risk and compliance address, an anti-money laundering investigations address, a corporate fraud investigations address, an anti-money laundering sanctions team address and an economic sanctions team address.

10. A method for electronically processing customer information, one or more non-transitory computer-readable media storing computer-executable instructions which, when executed by a processor on a computer system, perform for identifying and escalating risk-related data, the method comprising:
using a receiver to receive information relating to a customer, said information that satisfies pre-determined criteria, said pre-determined criteria that qualifies the customer as a high risk customer, from one of a plurality of third party vendors, the information including a client identification number, a client tax number and a client social security number;
using a processor to assess, in response to a user login, all roles to which the user is entitled, and to display on a graphical user interface (“GUI”) a plurality of user roles in a drop-down menu, each of the plurality of roles being roles to which the user is entitled, and further using the processor to allow the user to use the drop-down menu for switching between the roles; and
in the event that the financial institution database includes information relating to the high risk customer, the processor is further configured to transfer the information to one or more of a plurality of receivers.

10. The method of claim 9, wherein the processor is further configured to display an application administrator role in the drop-down menu, the application administrator role comprising the ability to create and maintain risk type templates.

11. The method of claim 10, wherein the processor is further configured to display a risk definition acceptance tester role in the drop-down menu, the risk definition acceptance tester role comprising the ability to approve a new and/or updated risk type process created by the application administrator role.

12. The method of claim 9, wherein the processor is further configured to display a user administrator role in the drop-down menu, the user administrator role comprising the ability to control tracking tool user access.

13. The method of claim 10, wherein the processor is further configured to display a risk definition unit tester role in the drop-down menu, the risk definition unit tester role comprising the ability to test new or update risk type template created by the application administrator.

14. The method of claim 9, wherein the processor is further configured to display a risk tracking role in the drop-down menu, the risk tracking role comprising entitlements based on the risk type, the entitlements comprising manager, processor and read only.

15. The method of claim 9, wherein the risk type comprises at least one of a financial derogatory alert, a negative news alert, a senior political figure alert, a defect tracking alert, an account closure recommendation alert, an economic sanctions alert, a corporate security alert, an investigative team account closure recommendation alert, a high risk/special policy review alert, a red flag escalation alert, a client background, a credit underwriting alert, a pre-entry prevention alert and any other suitable alert.

16. The method of claim 9, wherein the plurality of receivers includes at least one of a line of business risk and compliance address, an anti-money laundering investigations address, a corporate fraud investigations address, an anti-money laundering sanctions team address and an economic sanctions team address.
